(19) United States
(12) Patent Application Publication
(10) Pub. No.: US 2018/0274357 A1
(43) Pub. Date: Sep. 27, 2018

(54) High-Resolution-Molded Mandrel

(71) Applicant: Halliburton Energy Services, Inc., Houston, TX (US)

(72) Inventors: Mikko Jaaskelainen, Katy, TX (US); Brian Vandellyn Park, Spring, TX (US); Seldon David Benjamin, Montgomery, TX (US)

(21) Appl. No.: 15/764,140

(22) PCT Filed: Nov. 2, 2015
(86) PCT No.: PCT/US2015/058550

§ 371 Date: Mar. 28, 2018

(51) Int. Cl. E21B 47/06; E21B 17/00; G01K 11/32; B29C 45/00; B29C 45/14

(52) U.S. Cl. CPC E21B 47/065; E21B 17/00; E21B 43/2406; B29C 45/0001; B29C 45/14622; G01K 11/3206

(57) ABSTRACT

A method may include coiling a fiber line around an exterior side of a casing section. A mold may be temporarily secured to at least a portion of the exterior side of the casing section. An epoxy material may be injected into the mold to form a cover. The cover may extend over the fiber line and the exterior of the casing section. The cover may have a substantially equal thickness for centralizing the casing section when the casing section is positioned downhole. The mold may be removed from the exterior side of the casing section after the epoxy material has cured.

### TECHNICAL FIELD

The present disclosure relates generally to mandrels used for positioning optical fiber downhole for sensing conditions downhole, and more specifically (although not necessarily exclusively), to mandrels formed by molding a cover over a casing section and a fiber line.

### BACKGROUND

Optical fiber can be run downhole to monitor various conditions of a wellbore. Some systems of measuring a specific condition within the wellbore, including distributed temperature sensing systems (“DTS” systems), can have limited spatial resolution. For example, the spatial resolution of a DTS system can be limited to about 1 meter. In some applications of a DTS system, including in steam-assisted gravity drainage (“SAGD”) monitoring wells, a greater spatial resolution can be desired. For example, SAGD monitoring wells can require a spatial resolution as fine as 5 centimeters.

### BRIEF DESCRIPTION OF THE DRAWINGS

FIG. 1 is a schematic of a well system including a molded mandrel positioned within a wellbore, according to an aspect of the present disclosure.

FIG. 2A is a perspective view of the molded mandrel of FIG. 1, according to an aspect of the present disclosure.

FIG. 2B is a perspective view of the molded mandrel of FIG. 1 with a cover of the molded mandrel shown as transparent, according to an aspect of the present disclosure.

FIG. 3 is a perspective view of a molded mandrel, according to another aspect of the present disclosure.

FIG. 4A is a perspective view of a molded mandrel that includes a first molded member and a second molded member, according to another aspect of the present disclosure.

FIG. 4B is a perspective view of an upper end of the first molded member of the molded mandrel of FIG. 4A, according to an aspect of the present disclosure.

FIG. 4C is a perspective view of a coupling location between the first molded member and the second molded member of the molded mandrel of FIG. 4A, according to an aspect of the present disclosure.

FIG. 4D is a perspective view of a fiber line at a lower end of the molded mandrel of FIG. 4A, according to an aspect of the present disclosure.

FIG. 5 is a cross-sectional side view of a stopper positioned within a fiber line of a molded mandrel, according to an aspect of the present disclosure.

FIG. 6A is a perspective view of a mold of a cover of the molded mandrel of FIGS. 1-2B positioned on the casing section, according to an aspect of the present disclosure.

FIG. 6B is a cross-sectional perspective view of the mold of the cover positioned on the casing section shown in FIG. 6A, according to an aspect of the present disclosure.

FIG. 7 is a perspective view of a mold of a retainer bar of the molded mandrel of FIGS. 4A-4D, according to an aspect of the present disclosure.

### DETAILED DESCRIPTION

Certain aspects and features of the present disclosure are directed to a molded mandrel that can include a cover molded over an exterior surface of a casing section over a fiber line. The fiber line can be coiled around the exterior surface of the casing section prior to molding the cover over the casing section and the fiber line. The casing section can be a standard casing section. The fiber line can receive an optical fiber for measuring a characteristic of a wellbore when the molded mandrel is positioned downhole. A mold of the cover can be formed using a three-dimensional (“3D”) printed mold. The mold of the cover can be temporarily secured over the fiber line and the exterior of the casing section. The mold can receive an epoxy that can fill the mold and bind to the casing section and the fiber line as it cures. The mold of the cover can be removed from the casing section when the epoxy has cured. The cured epoxy can form the cover over the exterior of the casing section and the fiber line. In some aspects, the cover can have a generally equal thickness at every point around the casing section and may act as a centralizer.

In some aspects, the cover can be a generally cylindrical cover that extends around a circumference of the casing section. The generally cylindrical cover can cover substantially all of the fiber line that is coded around the casing section. In other aspects, the cover can be one or more retainer bars that may be generally rectangular in shape. The one or more retainer bars may be positioned over portions of the casing section and the fiber line and may retain the fiber line in position on the exterior surface of the casing section.

The cover can protect the fiber line and the optical fiber positioned within the fiber line. In some aspects, the optical fiber can be positioned within the fiber line when the fiber line is positioned around the casing section of the molded mandrel. In some aspects, the optical fiber can be pumped into the fiber line from the surface when the molded mandrel having the cover are positioned downhole. The optical fiber can transmit information from downhole (e.g., temperature data, acoustic data, pressure data) to a computing device at the surface.

These illustrative aspects are given to introduce the reader to the general subject matter discussed here and are not intended to limit the scope of the disclosed concepts. The following sections describe various additional features and aspects with reference to the drawings in which like numerals indicate like elements, and directional descriptions are used to describe the illustrative aspects but, like the illustrative aspects, should not be used to limit the present disclosure.

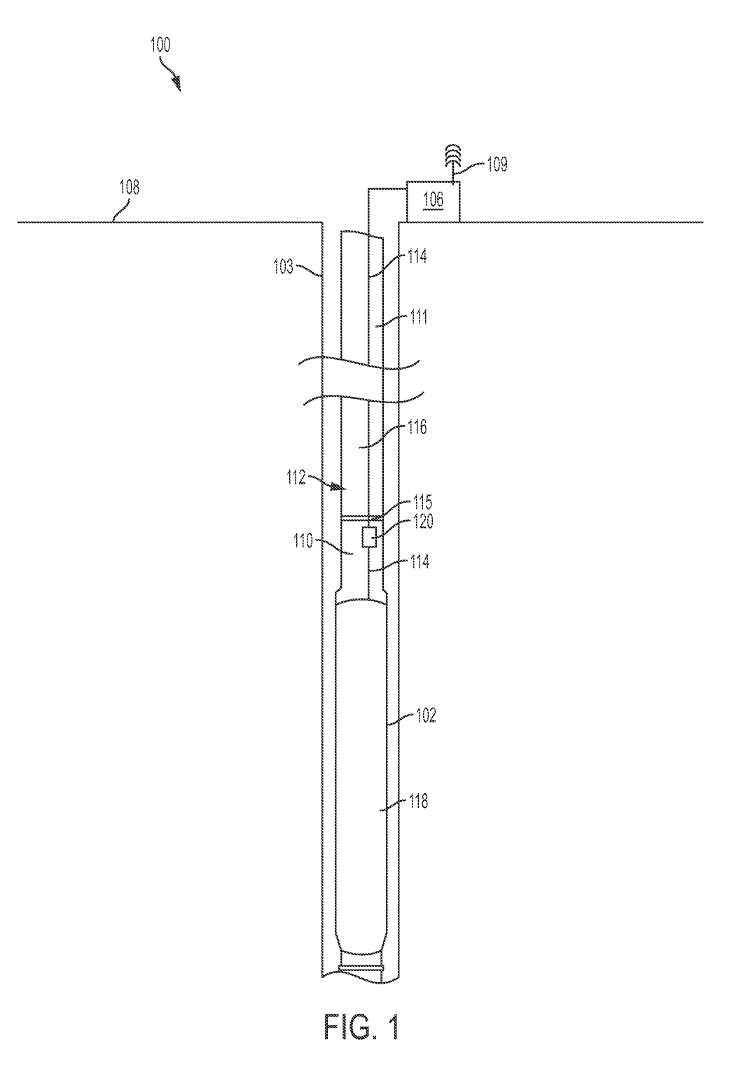

FIG. 1 is a schematic of a well system 100 having a molded mandrel 102 positioned downhole in a wellbore 103. The molded mandrel 102 can include a casing section 110. Additional casing sections 111 can be coupled to the molded mandrel 102 to form a casing string 112 that extends from a surface 108 of the wellbore 103 downhole. The additional casing section 111 can be coupled to the molded mandrel 102 by a casing collar 115. A tubing, for example a fiber line 114, may be coiled around an exterior surface 116 of the casing section 110. An optical fiber 104 (not shown) can be positioned within the fiber line 114. The molded mandrel 102 can also include a cover 118 that can cover substantially all of the fiber line 114 coiled around the exterior surface 116 of the casing section 110. In some aspects, the cover 118 may cover only a portion of the fiber line 114 coiled around the casing section 110. The fiber line 114 can extend beyond the cover 118 and the optical fiber 104 positioned within the fiber line 114 can enter a splice housing 120 positioned on the casing section 110. Within the splice housing 120 the optical fiber 104 can be spliced to an additional length of optical fiber 104 that can extend to the surface 108 within an additional length of fiber line 114.

The optical fiber 104 within the fiber line 114 can be in communication with a computing device 106 at a surface 108 of the wellbore 103. The computing device 106 can be a fiber optic interrogator that includes a computing device. In some aspects, the computing device 106 may be an opto-electric system that includes a computing device. The fiber line 114 that contains the optical fiber 104 can extend along the length of the casing string 112 to the computing device 106 at the surface 108. The optical fiber 104 can collect data related to various conditions downhole in the wellbore, for example but not limited to temperature data, acoustic data, or pressure data. The optical fiber 104 can transmit the data to the computing device 106 at the surface 108. The computing device 106 can transmit the data away from the surface 108 via a communication link 109. In some aspects, the communication link 109 can be wireless and may include wireless interfaces such as IEEE 802.11, Bluetooth, or radio interfaces for accessing cellular telephone networks (e.g., transceiver/antenna for accessing a CDMA, GSM, UMTS, or other mobile communications network). In other aspects, the communication link 109 can be wired and can include interfaces such as Ethernet, USB, IEEE 1394, or a fiber optic interface. In some aspects, the computing device 106 can be a fiber optic interrogator with a computing device, where the fiber optic interrogator may be a distributed temperature sensing (DTS) system, a distributed acoustic sensing (“DAS”) system, or an Fiber Bragg Grating (“FBG”) based sensing system. In some aspects, additional optical fibers 104 may be positioned within the fiber line 114 for monitoring additional conditions within the wellbore 103, for example pressure within the wellbore.

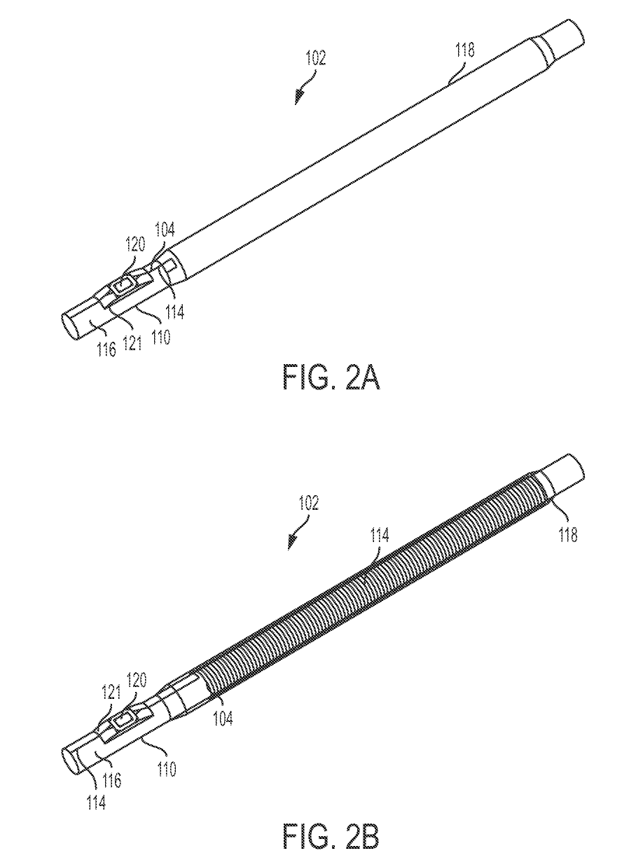

FIG. 2A is a perspective view of the molded mandrel 102 from FIG. 1 and FIG. 2B is a perspective view of the molded mandrel 102 with the cover 118 shown as transparent to provide a view of the fiber line 114 coiled around an exterior surface 116 of the casing section 110. As shown in FIGS. 2A and 2B, the cover 118 can extend along the length of the casing section 110 that includes the fiber line 114. The optical fiber 104 can be positioned within the fiber line 114 when the fiber line 114 is coiled around the casing section 110. The fiber line 114 can extend beyond the cover 118 and the optical fiber 104 positioned within the fiber line 114 can enter the splice housing 120. The optical fiber 104 can be spliced to another length of optical fiber 104 in the splice housing 120. The splice housing 120 can also be secured to a mounting 121. The mounting 121 may be molded to the casing section 110. The additional length of optical fiber 104 may be positioned within an additional length of fiber line 114 and both may extend to the surface of the wellbore. The molded mandrel 102 can be coupled to a casing section.

As shown in FIG. 2B the fiber line 114 that contains the optical fiber 104 can be coiled around the exterior surface 116 of the casing section 110. The distance between each coil of fiber line 114 can correspond to the pitch of the fiber line 114, and thereby the pitch of the optical fiber 104 positioned within the fiber line 114. The pitch of the optical fiber 104 can correspond to the spatial resolution (or accuracy) of a measurement (e.g., temperature, acoustic, pressure) taken by the optical fiber 104. The spatial resolution of a DTS system that includes the optical fiber 104 and a computing device, for example computing device 106, can be greater when the optical fiber 104 is coiled around the casing section 110 as compared to if the optical fiber 104 was positioned linearly along the length of the casing section 110. Similarly, the spatial resolution and sensitivity of a DAS system that includes the optical fiber 104 and computing device 106 can be altered based on the pitch of the optical fiber 104 positioned around the casing section 110.

Some wells require higher spatial resolution, for example but not limited to Steam Assisted Gravity Drainage (“SAGD”) monitoring wells, which can require spatial resolutions as accurate as 5 cm per 1 meter length. The pitch of the optical fiber 104 around the casing section 110 can after the spatial resolution. A desired spatial resolution can be achieved by altering the pitch of the optical fiber 104. The pitch of the optical fiber 104 needed to achieve the desired spatial resolution can depend on the diameter of the casing section 110, for example as described in the following equation: Pitch=(S)×π×(D_{c}/1 meter) where S is the desired spatial resolution and D, is the diameter of the casing section 110. Thus, to achieve the 5 cm resolution desired for a SAGD monitoring well, a casing section 110 having a diameter of 3.5 inches can have an optical fiber 104 coiled with a pitch of approximately 0.55 inch; Similarly, to achieve the 5 cm resolution desired for a SAGD monitoring well when the casing section 110 has a diameter of 4.5 inches, the optical fiber 104 may be coiled with a pitch of approximately 0.7 inch. A casing section 110 having a diameter of 5.5 inches could have an optical fiber 104 coiled with a pitch of approximately 0.86 inch to achieve the 5 cm resolution desired for a SAGD monitoring well. To achieve various other desired spatial resolution values, the pitch of the optical fiber 104 can be correspondingly increased or decreased based on the diameter of the casing section 110.

The cover 118 can cover and protect the fiber line 114. By covering and protecting the fiber line 114, the cover 118 can maintain the pitch of the optical fiber 104. The cover 118 may also protect the optical fiber 104 positioned within the fiber line 114. The cover 118 can have a substantially uniform thickness around the casing section 110 along a length of the cover 118. The cover 118 can act as a centralizer when the molded mandrel 102 is positioned downhole because of its substantially uniform thickness about the casing section 110. The cover 118 can be formed using a mold.

FIG. 5A shows a mold 500 positioned on the casing section 110 over the fiber line 114. The mold 500 can include an upper half 502 and a lower half 504. The mold 500 can comprise a plastic resin, a metal or other suitable material. The upper half 502 and the lower half 504 when positioned together around the casing section 110, can cover the circumference of the casing section 110. For example, each of the upper half 502 and the lower half 504 can extend approximately halfway around the circumference of the casing section 110. In some aspects, the mold 500 can be formed using 3D printing or other suitable means.

Each of the upper half 502 and the lower half 504 can include a flange 506 that extends outwardly. FIG. 5B shows a cross-sectional view of the mold 500 on the casing section 110. As shown in FIG. 5B, the flanges 506 of the upper half 502 and the lower half 504 can be positioned against one another when the upper half 502 and the lower half 504 are positioned on the casing section 110. The flanges 506 can include openings 508 for receiving fasteners 510. The upper half 502 and the lower half 504 of the mold 500 can be positioned over the portion of the casing section 110 that includes the fiber line 114 (holding the optical fiber 104) coiled around the casing section 110 via the fasteners 510. In some aspects, the mold 500 may be temporarily secured around the casing section 110 using clamps or by adhesive means, for example an adhesive tape.

The upper half 502 and the lower half 504 of the mold 500 can each include apertures 512 along the length of the mold 500. Epoxy can be injected into the apertures 512 and may enter the upper half 502 and the lower half 504. Air may exit the mold 500 via the apertures 512 as the epoxy is injected into the mold 500. As a section of the mold 500 proximate to an aperture 512 is filled with epoxy, that aperture 512 may be covered (e.g., by tape) and more epoxy may be injected into the next aperture 512. Once the epoxy has filled the upper half 502 and the lower half 504 of the mold 500 it can be left to cure, for example for twenty-four hours. In some aspects, the epoxy is an epoxy carbon or other suitably resin material. After the epoxy has cured, the upper half 502 and the lower half 504 can be removed from the casing section 110. The cured epoxy can thereby form the cover 118 that surrounds and protects the fiber line 114 coiled around the casing section 110.

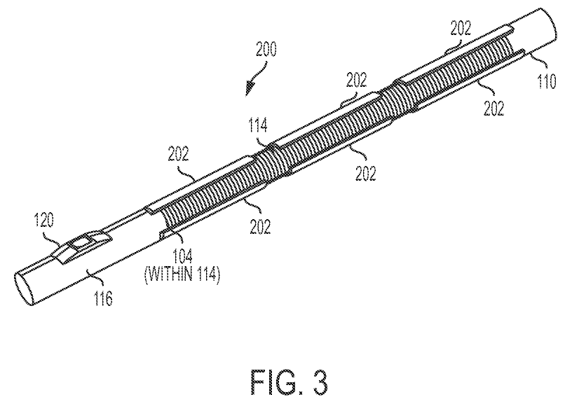

FIG. 3 shows a molded mandrel 200 according to another aspect. The molded mandrel 200 can include the casing section 110 and a cover positioned on the exterior surface 116 of the casing section 110. The cover may be for example one or more retainer bars 202. The fiber line 114 can be coiled around the exterior surface 116 of the casing section 110. The optical fiber 104 can be positioned within the fiber line 114 at the time the fiber line 114 is positioned around the casing section 110. The retainer bars 202 can be molded onto the casing section 110 over the fiber line 114. Portions of the fiber line 114 positioned between the retainer bars 202 can be exposed to conditions within the wellbore, for example to fluid in the wellbore when the molded mandrel 200 is positioned downhole. In some aspects, the optical fiber 104 can provide more accurate measurements of conditions within the wellbore (e.g., temperature, pressure, or acoustic measurements) when the fiber line 114 is exposed from the retainer bars 202 or other cover.

As described with respect to FIGS. 2A-2B the fiber line 114 can extend out from beneath the retainer bars 202 to the splice housing 120. The optical fiber 104 within the fiber line 114 can be spliced to an additional length of optical fiber 104 within the splice housing 120. The optical fiber 104 can in this way extend from the molded mandrel 200 to the surface of the wellbore. In some aspects, the molded mandrel 200 can be coupled to another molded mandrel 200 and the optical fibers 104 of each mandrel can be spliced together at one or more splice housings 120.

As described with respect to FIG. 2B the distance between each coil of fiber line 114 can correspond to the pitch of the fiber line 114, and the optical fiber 104 positioned within the fiber line 114. The pitch of the optical fiber 104 can correspond to the spatial resolution (or accuracy) of a temperature measurement taken by the optical fiber 104. The retainer bars 202 can maintain the position of the fiber line 114 (and the optical fiber 104 positioned therein) at a pitch that corresponds to a desired spatial resolution. The retainer bars 202 can have a substantially uniform thickness. The retainer bars 202 can act as a centralizer when the molded mandrel 200 is positioned downhole because of the substantially uniform thickness of the retainer bars 202 on the exterior surface 116 of the casing section 110.

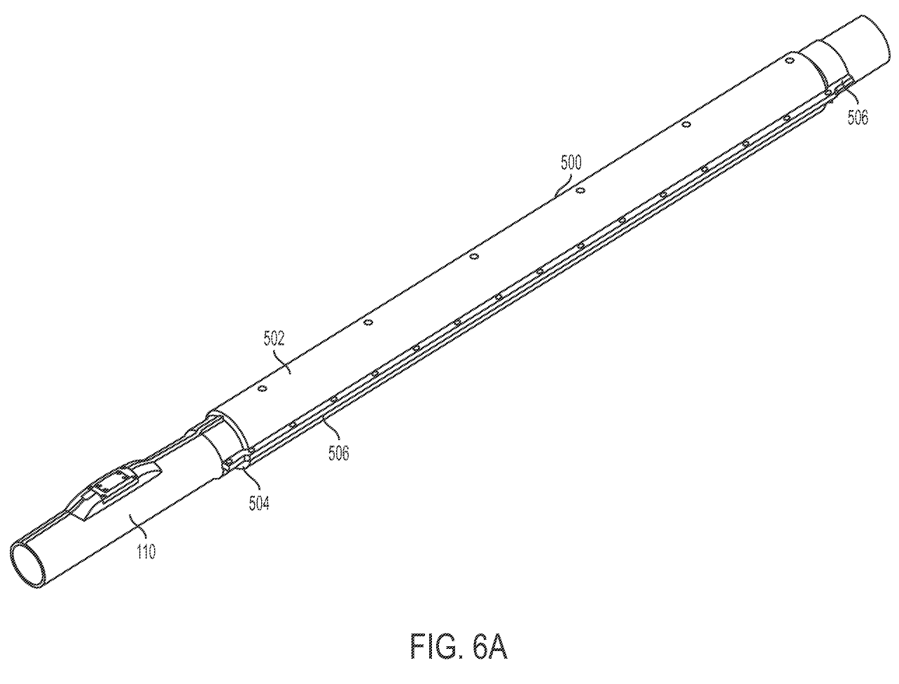

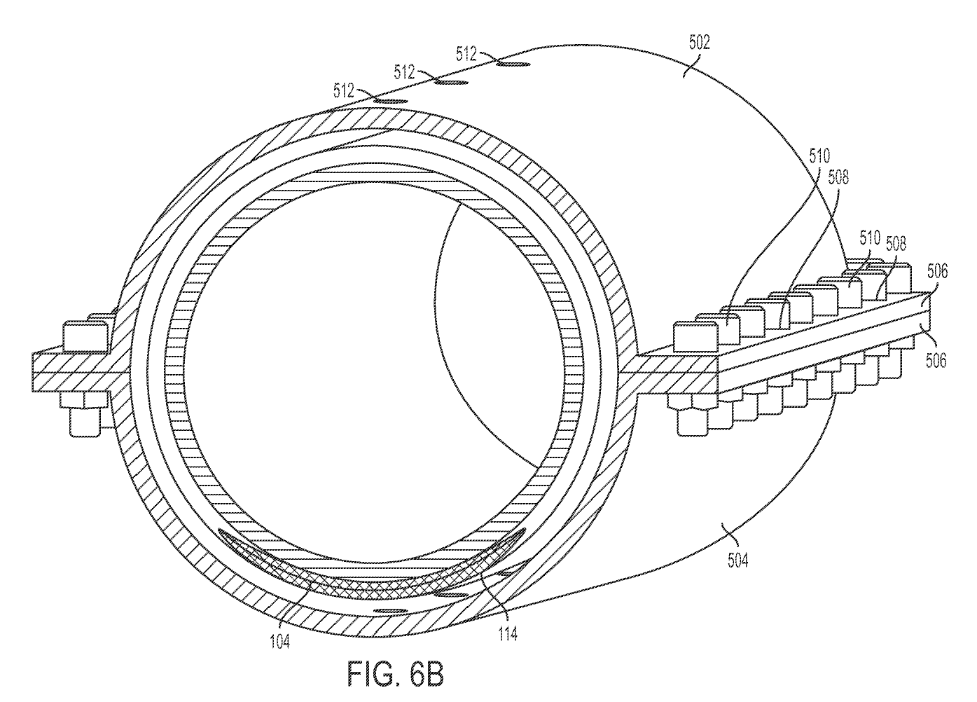

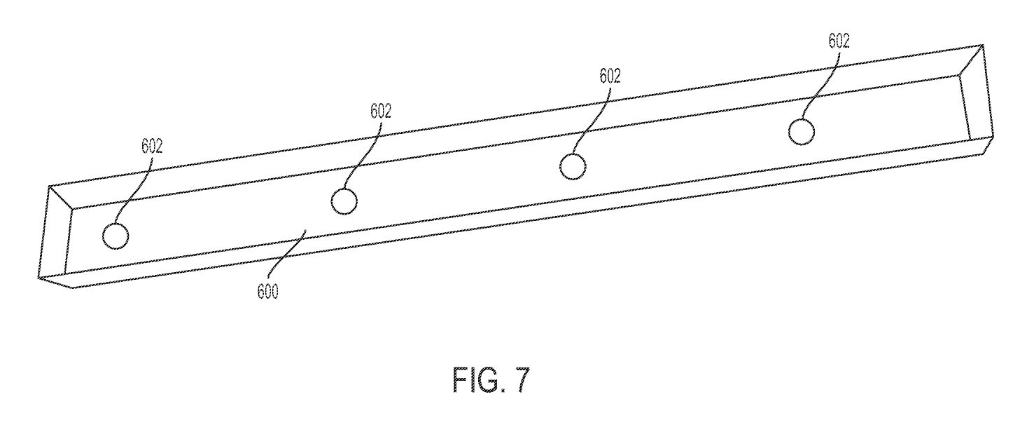

The retainer bars 202 can be formed using a mold. FIG. 6 shows a mold 600 of the retainer bars 202 prior to positioning on the casing section 110, according to an aspect of the present disclosure. The mold 600 can be in the shape of a single retainer bar 202 and can be formed using 3D printing or other suitable means. One or more molds 600 of the retainer bar 202 can be temporarily secured in place over the portion of the casing section 110 that includes the fiber line 114 (holding the optical fiber 104) coiled around the casing section 110. For example, a mold of one retainer bar 202 may be secured to the casing section 110 using damps or by adhesive means (e.g. tape). The mold 600 may comprise plastic resin, metal or other suitable material. An epoxy, for example an epoxy carbon, can be injected into and fill the mold. The epoxy can be left to cure within the mold. After the epoxy has cured, the mold of the retainer bar 202 can be removed from the casing section 110. The cured epoxy thereby forms the retainer bars 202 that surrounds and protects the fiber line 114 coiled around the casing section 110.

In some aspects, the mold 600 of the retainer bar can include a curved portion that may extend partially around the casing section 110. The mold 600 may include a flange for coupling the mold 600 to an additional molded member that extends partially around the remainder of the casing section 110 to secure the mold 600 in place around the casing section.

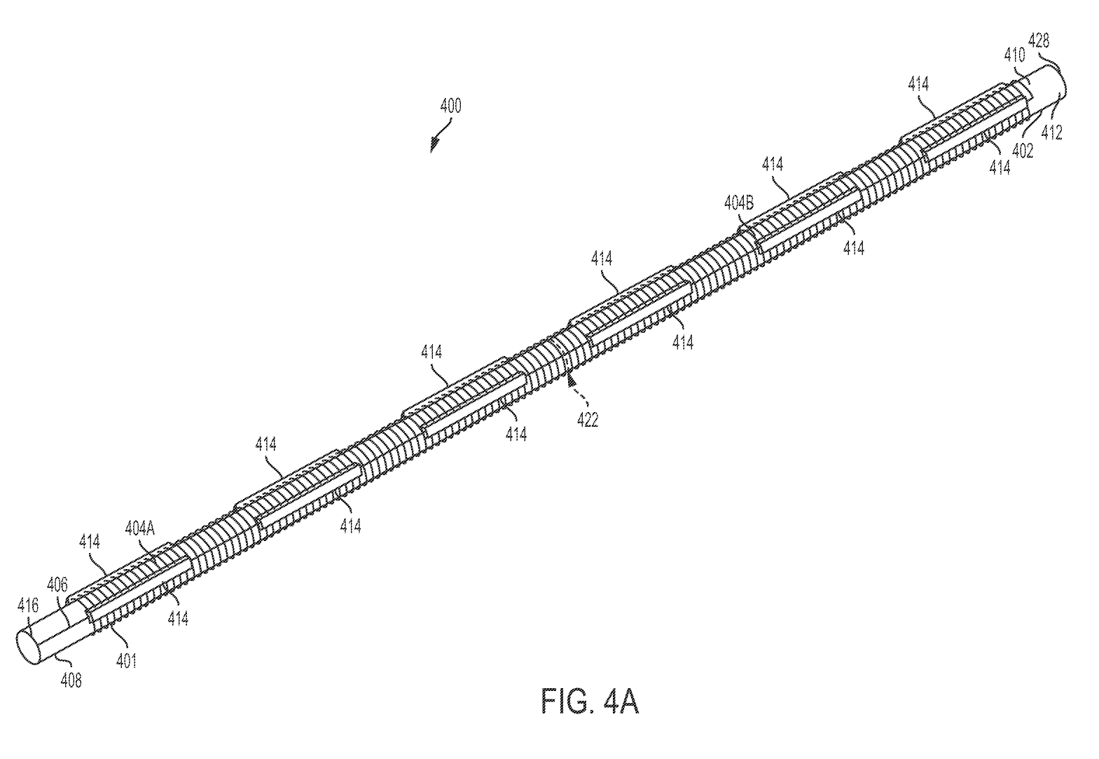

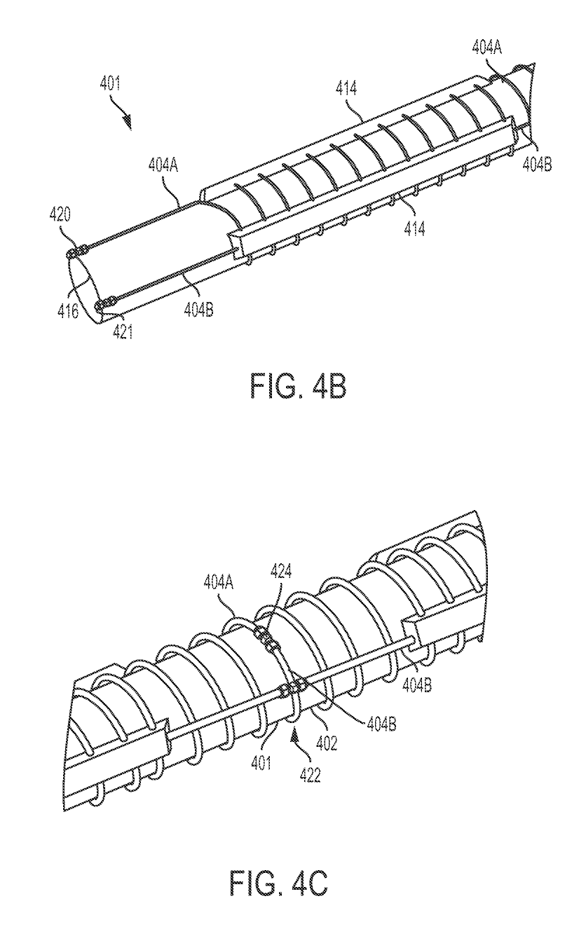

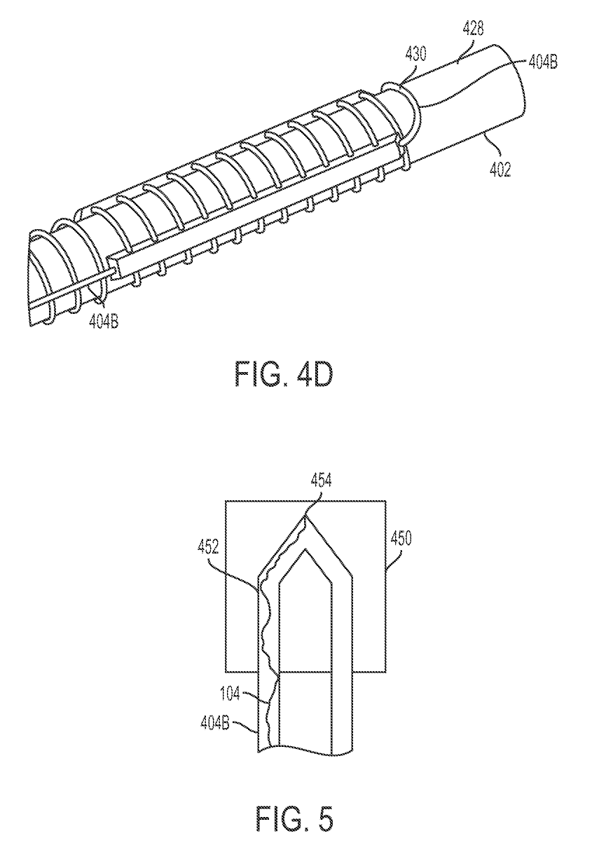

FIG. 4A shows a molded mandrel 400 according to another aspect of the present disclosure. The molded mandrel 400 can include a first molded member 401 and a second molded member 402 coupled together at a coupling location 422. The first molded member 401 and the second molded member 402 may be coupled together by a casing collar (not shown) or other suitable means. The molded mandrel 400 can have an increased length as compared to other mandrels by coupling the first molded member 401 with the second molded member 402. The molded mandrel 400 can monitor a larger pay zone than mandrels having a shorter length.

A fiber line 404A may be positioned at an upper end 416 of the first molded member 401. The fiber line 404A may coil around an exterior surface 406 of a casing section 408 of the first molded member 401. The fiber line 404A may be coupled to a fiber line 404B as described below. The fiber line 404B may be coiled around an exterior surface 410 of a casing section 412 of the second molded member 402. At a lower end 428 of the second molded member 402, the fiber line 404B may curve and extend linearly along the length of the second molded member 402 and first molded member 401. The lower end 428 of the second molded member 402 may be positioned downhole relative to the upper end 416 of the first molded member 401. The molded mandrel 400 may be positioned downhole without an optical fiber positioned within the fiber line 404A, 404B. As describe further below, an optical fiber can be pumped into the fiber line 404A, 404B from the surface of the wellbore when the molded mandrel 400 is positioned downhole.

The fiber line 404A coiled around the first molded member 401 can be retained in place by a cover, for example retainer bars 414. The fiber line 404B coiled around the second molded member 402 may also be retained in place by retainer bars 414. The pitch of the fiber line 404A, 404B, can define the pitch of an optical fiber positioned within the fiber line 404A, 404B. The pitch of the optical fiber can be selected to achieve the desired spatial resolution based on the diameter of the casing sections 408, 412, as described with respect to FIGS. 2A-2B.

FIG. 4B shows the upper end 416 of the first molded member 401. An end of the fiber line 404A proximate to the upper end 416 may be coupled to an additional fiber line via a compression fitting 420. The additional fiber line may extend to the surface of the wellbore. An end of the fiber line 404B proximate to the upper end 416 may be coupled to an additional fiber line via a compression fitting 421. That additional fiber line may also extend to the surface of the wellbore.

The optical fiber and a fluid may be pumped into the fiber line 404A from the surface when the molded mandrel 400 is positioned downhole. The optical fiber can travel with the fluid as it is pumped into fiber lines 404A, 404B. The optical fiber can thereby be positioned within the fiber line 404A as it coil around the exterior surface 406 of the first molded member 401. The optical fiber can also thereby be positioned within the fiber line 404B as it coils around the exterior surface 410 of the second molded member 402. In some aspects, the optical fiber can be stopped within the fiber line 404B near the lower end 428 of the second molded member 402 (see FIG. 4D) by a stopper, for example a turnaround sub. The fluid can continue to flow beyond the stopper in the fiber line 404B and may return to the upper end 416 of the first molded member 401 via the linear return path of the fiber line 404B (see FIG. 4D). In some aspects, as shown in FIG. 4A, 4D, no stopper may be used and the optical fiber 104 may be positioned within the fiber line 404B and may return to the upper end 416 of the first molded member 401. The fiber line 404B can be coupled to an additional fiber line at the upper end 416 by a compression fitting 432. The additional fiber line can extend to the surface for providing the return path for the fluid pumped into the fiber line 404A with the optical fiber 104.

FIG. 4C shows the first molded member 401 coupled to the second molded member 402 at the coupling location 422. The fiber line 404A may be coupled to the fiber line 404B by a compression fitting 424. The compression fitting 424 may be positioned proximate to the coupling location 422. The optical fiber can continue to flow with the fluid along the length of the fiber line 404A, through the compression fitting 424, and into the fiber line 404B. The fiber line 404B, and thereby the optical fiber pumped from the surface, may coil around a length of the second molded member 402.

FIG. 4D shows an enlarged view of the lower end 428 of the second molded member 402. At the lower end 428 the fiber line 404B can cease being coiled around the second molded member 402. The fiber line 404B can rotate and curve back towards the upper end 416 at a return curve 430. The fiber line 404B can then extend along the length of the second molded member 402 and the first molded member 401 back to the upper end 416 of the first molded member 401. The fiber line 404B extending along the length of the first and second molded members 401, 402 can act as a return path for the fluid pumped into the fiber line 404A from the surface. The optical fiber can flow along the length of the second molded member 402 with the fluid pumped from the surface.

FIG. 5 shows a cross-sectional lateral view of a turn-around sub 450 coupled to a fiber line, for example fiber line 404B proximate to a return curve, according to an aspect of the present disclosure. The fiber line 404B can be coupled to a stopper, for example a turn-around sub 450 proximate to the return curve 430. In some aspects, the turn-around sub 450 can be positioned elsewhere along the length of the fiber line 404B or omitted entirely. The turn-around sub 450 can include a fiber line 452 having a sharp turn 454. The sharp turn 454 in the fiber line 452 can catch and stop the optical fiber 104. The sharp turn 454 of the turn-around sub 450 can allow the fluid to pass beyond the sharp turn 454 and continue flowing along the length of the fiber line 404B towards the surface of the wellbore. In some aspects, the stopper can be a different mechanical feature, mechanical device, electric device, or other suitable means for stopping the optical fiber 104 while allowing the fluid to pass beyond the stopper.

### EXAMPLE #1

An apparatus may comprise a casing section and a fiber line coiled around an exterior surface of the casing section. The fiber line may be for receiving an optical fiber. The apparatus may also comprise a cover formed from a mold. The cover may be external to at least part of the fiber line. The cover may be for stabilizing the fiber line.

### EXAMPLE #2

The apparatus of Example #1 may also feature the cover including at least one bar that is generally rectangular in shape.

### EXAMPLE #3

The apparatus of Example #1 may also feature the cover being generally cylindrical in shape and surrounding substantially all of the fiber line.

### EXAMPLE #4

The apparatus of any of the Examples #1-3 may also feature a mount for receiving a splice housing. The mount may be formed from a three-dimensional printed mold.

### EXAMPLE #5

The apparatus of any of the Examples #1-4 may also feature the fiber line being coiled around the exterior surface of the casing section at a desired pitch for increasing a spatial resolution of the optical fiber positioned within the fiber line.

### EXAMPLE #6

The apparatus of any of the Examples #1-5 may also feature the cover having a generally uniform thickness for centralizing the casing section.

### EXAMPLE #7

The apparatus of any of the Examples #1-6 may also feature a compression fitting for connecting the fiber line to an additional an additional fiber line coiled around an additional casing section. The apparatus may also include a return fiber line that extends linearly along the exterior surface of the casing section.

### EXAMPLE #8

The apparatus of Example #5 may also feature the optical fiber being for measuring temperature data downhole in a wellbore. In addition, the selected pitch of the optical fiber may be for providing a desired level special resolution of temperature data.

### EXAMPLE #9

Any of the apparatus of Examples #1-8 may feature the cover being molded using an epoxy material injected into the mold of the cover temporarily positioned on the casing section.

### EXAMPLE #10

The apparatus of any of Examples #1-9 may feature the mold of the cover being a three-dimensional printed mold.

### EXAMPLE #11

A method can comprise coiling a fiber line around an exterior surface of a casing section. A mold can be temporarily secured to the exterior surface of the casing section over a portion of the fiber line. Epoxy material can be injected into the mold for forming a cover over the portion of the fiber line and the exterior of the casing section. The mold can be removed from the exterior side of the casing section after the epoxy material has cured to form the cover.

### EXAMPLE #12

The method of Example #11 can further feature the mold being a three-dimensional printed mold.

### EXAMPLE #13

The method of any of Examples #11-12 can further feature the mold being substantially the same length as the casing section.

### EXAMPLE #14

The method of any of Examples #11-13 can further feature the mold being a substantially constant width for forming the cover having a substantially constant thickness for centralizing the casing section.

### EXAMPLE #15

The method of any of Examples #11-14 can further feature the mold comprising two or more three-dimensional printed mold members.

### EXAMPLE #16

The method of Example #15 may further feature the two or more three-dimensional printed mold members each being generally rectangular in shape.

### EXAMPLE #17

An apparatus may comprise a casing section for use downhole in a wellbore. The apparatus may include a fiber line coiled around an external wall of the casing section at a selected pitch, the fiber line for receiving an optical fiber. The apparatus may also include two or more retainer bars, where each retainer bar may be formed from a mold. The two or more retainer bars may be for stabilizing the fiber line and centralizing the casing section when it is positioned downhole.

### EXAMPLE #18

The apparatus of Example #17 may further feature a mount for receiving a splice housing. The mount may be formed from a three-dimensional printed mold.

### EXAMPLE #19

Any of the apparatus of Examples #17-18 may further feature the optical fiber being for measuring temperature data downhole in the wellbore. The selected pitch of the optical fiber may be for providing a desired level special resolution of the temperature data.

### EXAMPLE #20

Any of the apparatus of Examples #17-18 may further feature the optical fiber being for measuring acoustic data downhole in the wellbore. The selected pitch of the optical fiber may be for providing a desired level special resolution of the acoustic data.

The foregoing description of certain aspects, including illustrated aspects, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. An apparatus comprising:
a casing section;
a fiber line coiled around an exterior surface of the casing section for receiving an optical fiber; and
a cover formed from a mold, the cover external to at least part of the fiber line for stabilizing the fiber line.

2. The apparatus of claim 1, wherein the cover includes at least one bar that is generally rectangular in shape.

3. The apparatus of claim 1, wherein the cover is generally cylindrical in shape and surrounds substantially all of the fiber line.

4. The apparatus of claim 1, further comprising a mount for receiving a splice housing, the mount being formed from a three-dimensional printed mold.

5. The apparatus of claim 1, wherein the fiber line is coiled around the exterior surface of the casing section at a desired pitch for increasing a spatial resolution of the optical fiber positioned within the fiber line.

6. The apparatus of claim 1, wherein the cover has a generally uniform thickness for centralizing the casing section.

7. The apparatus of claim 1, further comprising:
a compression fitting for connecting the fiber line to an additional an additional fiber line coiled around an additional casing section; and
a return fiber line that extends linearly along the exterior surface of the casing section.

8. The apparatus of claim 5, wherein the optical fiber is for measuring temperature data downhole in a wellbore, and wherein the selected pitch of the optical fiber is for providing a desired level special resolution of temperature data.

9. The apparatus of claim 1, wherein the cover is molded using an epoxy material injected into the mold of the cover temporarily positioned on the casing section.

10. The apparatus of claim 9, wherein the mold of the cover is a three-dimensional printed mold.

11. A method comprising:
coiling a fiber line around an exterior surface of a casing section;
temporarily securing a mold to the exterior surface of the casing section over a portion of the fiber line,
injecting an epoxy material into the mold for forming a cover over the portion of the fiber line and the exterior of the casing section; and
removing the mold from the exterior side of the casing section after the epoxy material has cured to form the cover.

12. The method of claim 11, wherein the mold is a three-dimensional printed mold.

13. The method of claim 11, wherein the mold is substantially the same length as the casing section.

14. The method of claim 11, wherein the mold has a substantially constant width for forming the cover having a substantially constant thickness for centralizing the casing section.

15. The method of claim 11, wherein the mold comprises two or more three-dimensional printed mold members.

16. The method of claim 15, wherein the two or more three-dimensional printed mold members are each generally rectangular in shape.

17. An apparatus comprising:
a casing section for use downhole in a wellbore;
a fiber line coiled around an external wall of the casing section at a selected pitch, the fiber line for receiving an optical fiber; and
two or more retainer bars, each retainer bar formed from a mold, the two or more retainer bars for stabilizing the fiber line and centralizing the casing section when positioned downhole.

18. The apparatus of claim 17, further comprising a mount for receiving a splice housing, the mount being formed from a three-dimensional printed mold.

19. The apparatus of claim 17, wherein the optical fiber is for measuring temperature data downhole in the wellbore, and wherein the selected pitch of the optical fiber is for providing a desired level special resolution of the temperature data.

20. The apparatus of claim 17, wherein the optical fiber is for measuring acoustic data downhole in the wellbore, and wherein the selected pitch of the optical fiber is for providing a desired level special resolution of the acoustic data.
